(19) United States
(12) Patent Application Publication
(10) Pub. No.: US 2017/0167455 A1
(43) Pub. Date: Jun. 15, 2017

(54) NEXT-GENERATION DIESEL FUEL FILTER INTEGRATED WITH FUEL PUMP

(71) Applicant: Hyundai Motor Company, Seoul (KR)

(72) Inventors: Jang Hyun Jung, Suwon (KR); N. Sreenivasan, Hyderabad (IN)

(21) Appl. No.: 15/213,507

(22) Filed: Jul. 19, 2016

(30) Foreign Application Priority Data
Dec. 14, 2015 (KR) 10-2015-0177938

(51) Int. Cl. F02M 37/22; B01D 35/00; B01D 36/00; B01D 29/90; B01D 35/143; B01D 35/153; F02M 37/00; B01D 35/26

(52) U.S. Cl. CPC F02M 37/221; F02M 37/223; F02M 37/0076; F02M 37/0023; B01D 35/005; B01D 35/26; B01D 29/90; B01D 35/1435; B01D 35/153; B01D 36/005

(57) ABSTRACT

A next-generation diesel fuel filter integrated with a fuel pump is provided to improve safety in the event of a collision and the reliability of fuel supply when traveling on an inclined road. The fuel filter integrated with a fuel pump has a structure in which a fuel filter and a fuel pump are combined and mounted in a fuel tank, to prevent damage to the fuel filter. The integrated filter includes a unit for collecting water filtered out of fuel, a unit for sensing the collected water and transmitting a warning signal indicating water removal. Additionally, a flow passage switching unit enables water removal work, thereby removing water at a suitable time and improving the performance of a diesel fuel system.

### CROSS-REFERENCE TO RELATED APPLICATION

This application claims under 35 U.S.C. §119(a) the benefit of priority to Korean Patent Application No. 10-2015-0177938 filed on Dec. 14, 2015, the entire contents of which are incorporated herein by reference.

### BACKGROUND

(a) Technical Field

The present invention relates to a next-generation diesel fuel filter integrated with a fuel pump, and more particularly, to a next-generation diesel fuel filter integrated with a fuel pump, in which a diesel fuel filter and a fuel pump of a vehicle fuel system are combined, thereby improving safety in the event of a collision and the reliability of fuel supply when traveling on an inclined road.

(b) Background Art

In general, a diesel engine is widely used for industrial machinery, ships, vehicles, etc. due to its high thermal efficiency and low fuel cost. Research into fuel injection and engine rotation has been conducted, and the research is leading to the development of improved diesel engines having increased output performance and reduced exhaust fumes. Therefore, the application range and object of improved diesel engines are expanding.

Furthermore, diesel oil, which is used as a fuel of a diesel engine, contains a substantial amount of impurities and water. Therefore, a filtering process for removing impurities and water is required, and a fuel filter that performs the filtering process is used. For example, a fuel supply system of a diesel vehicle comprises a fuel tank, a fuel pump, a fuel filter, an injection pump, an injection nozzle, etc. The fuel supply system performs a series of processes of filtering the fuel in the fuel tank, feeding the fuel to the injection pump of an engine unit, adjusting the amount and time of fuel injection based on the operation state of the engine unit, and injecting the fuel into a combustion chamber through the injection nozzle.

In many cases, a fuel filter used in a diesel engine is mounted to a dash panel or a strut housing within an engine compartment of a vehicle. However, as relatively compact vehicles are being introduced on the market and recently developed vehicles are designed to improve passenger comfort in a passenger compartment of a vehicle, the available space in an engine compartment is gradually decreasing, and thus the space for mounting a fuel filter in an engine compartment is also gradually decreasing. Particularly, as the gap between a fuel filter and peripheral components decreases, a fuel filter is likely to be damaged by impact directly applied thereto in the event of a vehicle collision, which may cause fuel leakage from the fuel filter and even the severe danger of a fire or explosion. For example, the North American diesel vehicle small overlap crash test results show the separation of wheels, collapse of an A-pillar, separation of doors, and diesel oil leakage from a diesel filter attributable to serious damage to safety components in an engine compartment. Accordingly, a more fundamental approach to prevent the problems associated with a fuel filter is required.

The above information disclosed in this section is merely for enhancement of understanding of the background of the invention and therefore it may contain information that does not form the prior art that is already known in this country to a person of ordinary skill in the art.

### SUMMARY

The present invention provides a next-generation diesel fuel filter integrated with a fuel pump for a diesel fuel system of a vehicle, which has an innovative structure in which a fuel filter for removing water and dust and a fuel pump for supplying fuel are combined and mounted in a fuel tank, thus preventing damage to the fuel filter and ensuring safety in the event of a vehicle collision, and further meeting the requirements of the North American diesel vehicle small overlap crash test.

It is another object of the present invention to provide a next-generation diesel fuel filter integrated with a fuel pump, which may include a unit for collecting water filtered out of fuel, a unit for sensing the collected water and transmitting a warning signal indicating water removal, and a flow passage switching unit for enabling water removal work, thereby removing water at a suitable time and further improving the performance of a diesel fuel system including a diesel fuel filter.

In one aspect, the present invention provides a next-generation diesel fuel filter integrated with a fuel pump that may include a filter module having a fuel inlet, a fuel outlet and a plurality of filter papers, the filter module being mounted in a reservoir cup, and a pump module having a fuel suction aperture that communicates with an internal space of the reservoir cup and a fuel discharge aperture that communicates with the fuel inlet, the pump module being mounted in the filter module, and the pump module and the filter module being combined together and mounted in a fuel tank.

In an exemplary embodiment, the filter module may further include a mesh-shaped filter guide, a primary filter paper and a secondary filter paper for filtering fuel, and an outer case covered by an upper filter cover and a lower filter cover, the filter guide, the secondary filter paper, the primary filter paper and the outer case being concentrically and sequentially arranged from inside to outside.

In another exemplary embodiment, the next-generation diesel fuel filter integrated with a fuel pump may further include a water-collecting module configured to collect water filtered out of the fuel, the water-collecting module including a water dispenser and a water storing cup sequentially coupled to a lower end of the filter module, a water flow pipe connected to a first side of the water storing cup and extending upwards, and a water sensor mounted in the water storing cup to sense an amount of water.

In still another exemplary embodiment, the next-generation diesel fuel filter integrated with a fuel pump may further include a plurality of water backflow prevention valves mounted in water outlets of the water dispenser, each of the water backflow prevention valves having a housing having a water inflow aperture formed in an upper portion thereof and a water outflow aperture formed in a lower portion thereof, a valve plate mounted in the housing to move vertically to open and close the water inflow aperture, and a spring mounted in the housing to elastically support the valve plate upwards.

In yet another exemplary embodiment, the next-generation diesel fuel filter integrated with a fuel pump may further include an auxiliary reservoir cup mounted to a lower end of the filter module to store a predetermined amount of fuel, and the filter module may further include a plurality of positive temperature coefficient (PTC) heat-generating elements for heating fuel, the PTC heat-generating elements being mounted to an upper cover, disposed proximate to the fuel discharge aperture of the pump module and the fuel inlet and the fuel outlet of the filter module.

In still yet another exemplary embodiment, the next-generation diesel fuel filter integrated with a fuel pump may further include a flow passage switching valve configured to selectively perform an operation of supplying fuel or an operation of removing water, the flow passage switching valve including a valve case having two inlets connected with the fuel outlet of the filter module and connected with the water flow pipe of the water-collecting module, respectively, and an outlet connected to an engine, a plunger mounted in the valve case and supported by a spring to move and selectively block the two inlets of the valve case, and a solenoid for operating the plunger.

### BRIEF DESCRIPTION OF THE DRAWINGS

The above and other features of the present invention will now be described in detail with reference to exemplary embodiments thereof illustrated the accompanying drawings which are given hereinbelow by way of illustration only, and thus are not limitative of the present invention, and wherein:

FIGS. 1A-1B are views illustrating a next-generation diesel fuel filter integrated with a fuel pump according to an exemplary embodiment of the present invention;

FIGS. 2 and 3 are sectional views illustrating the next-generation diesel fuel filter integrated with a fuel pump according to the exemplary embodiment of the present invention;

FIG. 4 is a perspective view illustrating a filter module of the next-generation diesel fuel filter integrated with a fuel pump according to the exemplary embodiment of the present invention;

FIG. 5 is a perspective view illustrating a PTC heat-generating element mounted to an upper cover of the next-generation diesel fuel filter integrated with a fuel pump according to the exemplary embodiment of the present invention;

FIG. 6 is a perspective view illustrating a water backflow prevention valve of the next-generation diesel fuel filter integrated with a fuel pump according to the exemplary embodiment of the present invention; and

FIGS. 7A-7B are views illustrating a flow passage switching valve of the next-generation diesel fuel filter integrated with a fuel pump according to the exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment. In the figures, reference numbers refer to the same or equivalent parts of the present invention throughout the several figures of the drawing.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Hereinafter reference will now be made in detail to various exemplary embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

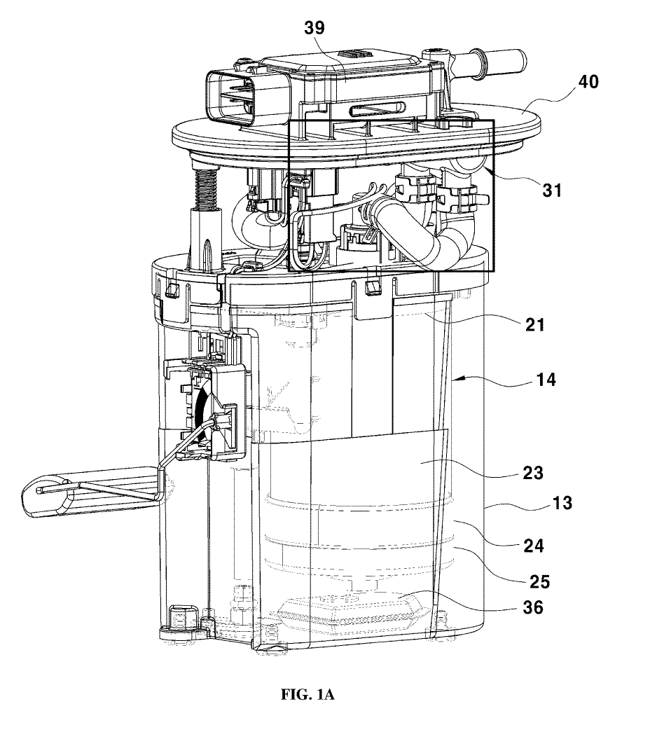

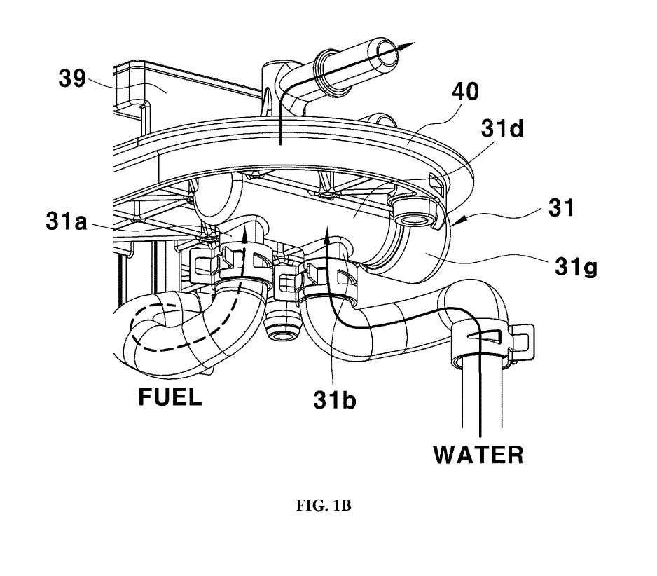

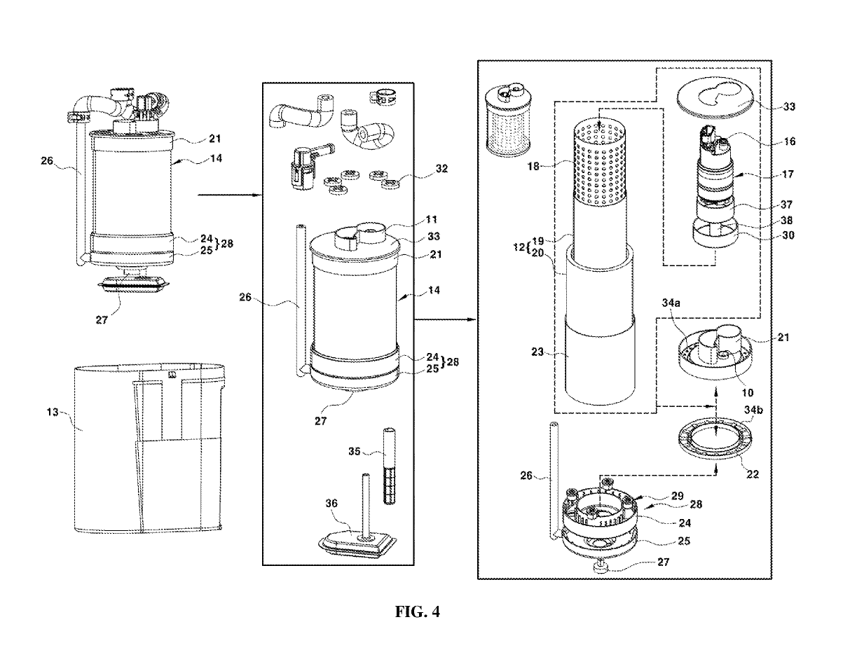

FIGS. 1A through 3 are a perspective view and sectional views illustrating a next-generation diesel fuel filter integrated with a fuel pump according to an exemplary embodiment of the present invention, and FIG. 4 is a perspective view illustrating a filter module of the next-generation diesel fuel filter integrated with a fuel pump according to the exemplary embodiment of the present invention.

As shown in FIGS. 1A through 4, the next-generation diesel fuel filter integrated with a fuel pump has a structure, in which a pump module and a filter module may be combined into a single assembly, and the assembly of the pump module and the filter module may be mounted in a fuel tank. Accordingly, the next-generation diesel fuel filter integrated with a fuel pump of the present invention may include a filter module 14 configured to filter fuel. In particular, the filter module 14 may be configured to remove impurities from fuel, and may include a fuel inlet 10, a fuel outlet 11 and a plurality of filter papers 12. The filter module 14 accommodated in a reservoir cup 13 may be mounted in the fuel tank.

Further, the filter module 14 may include a mesh-shaped filter guide 18, a primary filter paper 20 and a secondary filter paper 19 made of a non-woven fabric material or the like to filter the fuel, and an outer case 23, covered by an upper filter cover 21 and a lower filter cover 22. The filter guide 18, the secondary filter paper 19, the primary filter paper 20 and the outer case 23 may have a cylindrical shape, and may be concentrically and sequentially arranged from the inside (center portion) to the outside (outer periphery) to be spaced a predetermined distance apart from each other.

For example, the filter guide 18 may be disposed adjacent to the center portion, the secondary filter paper 19 and the primary filter paper 20 may be disposed around the filter guide 18, and the outer case 23 may be disposed around the filter paper. The upper end and the lower end of the assembly of the filter guide 18, the secondary filter paper 19, the primary filter paper 20 and the outer case 23 may be covered by the upper filter cover 21 and the lower filter cover 22.

The upper filter cover 21 and the lower filter cover 22 may include a plurality of fuel apertures 34a and 34b, arranged along the periphery in a circumferential direction to be spaced a predetermined distance from each other. The fuel, having passed through the fuel apertures 34a, may flow into the space defined between the outer case 23 and the primary filter paper 20, and the water, having passed through the fuel apertures 34b, may be delivered to a water dispenser 24, which will be described later. The fuel inlet 10 may be formed in the upper filter cover 21, and may be connected with a fuel discharge aperture 16 of a pump module 17. The fuel pumped from the pump module 17 may flow into the fuel inlet 10.

Accordingly, the fuel, pumped from the pump module 17 to flow into the fuel inlet 10, formed adjacent to the center portion of the upper filter cover 21, may flow into the space between the outer case 23 and the primary filter paper 20 through the fuel apertures 34a formed along the periphery of the upper filter cover 21, flow into the internal space of the filter guide 18 after sequentially passing through the primary filter paper 20 and the secondary filter paper 19, and then may be fed to a flow passage switching valve 31, which will be described later, through the fuel outlet 11 formed in the upper filter cover 21.

A fuel delivery pipe 35, disposed vertically inside the filter guide 18, may be mounted in the fuel outlet 11 to allow the fuel to flow to the fuel outlet 11 through the fuel delivery pipe 35. The next-generation diesel fuel filter integrated with a fuel pump of the present invention may further include a pump module 17 configured to pump fuel. The pump module 17 may include a fuel suction aperture 15, formed in the lower end portion and configured to communicate with the internal space of the reservoir cup 13, and a fuel discharge aperture 16, formed in the upper end portion and configured to communicate with the fuel inlet 10. The pump module 17 may be disposed inside the filter module 14, i.e., inside the filter guide 18, and may extend vertically. The top of the pump module 17 may be supported by an upper cover 33, disposed above the upper filter cover 21 by a predetermined distance.

The fuel discharge aperture 16 of the pump module 17 may be connected with the fuel inlet 10 formed in the upper filter cover 21 of the filter module 14. Therefore, the fuel discharged through the fuel discharge aperture 16 may flow into the space between the upper filter cover 21 and the upper cover 33. The fuel suction aperture 15 of the pump module 17 may be connected with a pipe that vertically extends upwards from a fuel pre-filter 36 disposed on the bottom in the reservoir cup 13. Accordingly, the fuel in the reservoir cup 13, pumped by the operation of the pump module, may flow into the pump module via the fuel pre-filter 36, the pipe and the fuel suction aperture 15, and then may flow out (e.g., may be discharged) through the fuel discharge aperture 16. The pipe may connect the fuel suction aperture 15 and the fuel pre-filter 36 while penetrating an auxiliary reservoir cup 30 and a water-collecting module 28, which will be described later.

The next-generation diesel fuel filter integrated with a fuel pump of the present invention may further include an auxiliary reservoir cup 30 in which a predetermined amount of fuel may be stored. The auxiliary reservoir cup 30 may have a circular cup shape, and may be supported by a supporting frame 38 which extends vertically from the bottom of a lower cover 37, which covers the lower end of the pump module 17. The auxiliary reservoir cup 30 may function as a bottom plate of the filter module 14 and thus, the outer circumferential surface of the auxiliary reservoir cup 30 may be in contact with the inner circumferential surface of the water dispenser 24 coupled to the lower end of the filter module 14.

Accordingly, even when a vehicle travels on an inclined road (e.g., a slope) and thus the fuel tank is in a slanted state, a particular amount of fuel may remain in both the reservoir cup 13 and the auxiliary reservoir cup 30. By virtue of this double reservoir cup structure, the reliability of fuel supply may be enhanced even in a low fuel level state, such as when traveling on an inclined road.

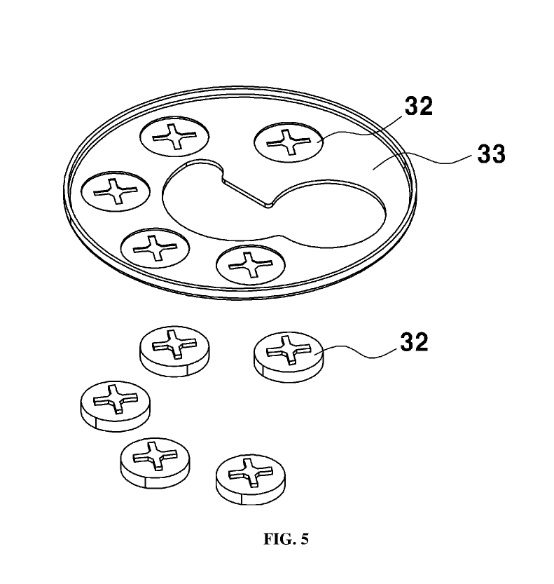

Furthermore, the next-generation diesel fuel filter integrated with a fuel pump of the present invention may include a PTC heater, for example, a plurality of PTC heat-generating elements 32 configured to heat fuel at a low temperature. As shown in FIG. 5, the PTC heat-generating elements 32, configured to generate heat when external power (not shown) is applied thereto, may be accommodated in the upper cover 33 or may be attached to the bottom surface of the upper cover 33, disposed proximate to the fuel discharge aperture 16 of the pump module 17 and the fuel inlet 10 and the fuel outlet 11 of the filter module 14. Accordingly, since the fuel may be heated by the heat-generating action of the PTC heat-generating elements 32, disposed proximate to the components through which the pumped fuel flows in and out, a cold start operation may be improved.

The next-generation diesel fuel filter may further include a water-collecting module 28 configured to collect water filtered out of the fuel. The water-collecting module 28 may include a water dispenser 24 configured to collect water falling (e.g., discharged) from the filter module 14, and a water storing cup 25 configured to store water delivered from the water dispenser 24. The water dispenser 24 may have an annular cup shape, and may be coupled to the lower end of the filter module 14, that is, the bottom surface of the lower filter cover 22. Therefore, the water dispenser 24 may be configured to receive water that drops or flows down through the fuel apertures 34b formed in the lower filter cover 22 due to the difference in specific gravity. The water storing cup 25 may have a circular cup shape, and may be coupled to the lower end of the water dispenser 24 to store water moving down through an outlet of the water dispenser 24, e.g., through a water backflow prevention valve 29, which will be described later.

A water sensor 27 configured to sense an amount of water may be mounted in the bottom of the water storing cup 25. The water sensor 27 may be configured to detect when the water stored in the water storing cup 25 reaches a predetermined level and may be configured to transmit the detection result to a controller 39. In response to receiving the detection result, the controller 39 may be configured to operate a warning lamp (not shown) to be turned on. Alternatively, the controller may be configured to operate another device capable of providing an indication of the detection result. The water sensor may be embodied as a typical sensor configured to sense a water level.

A water flow pipe 26 may be connected to a side surface of the water storing cup 25. Additionally, the water flow pipe 26 may extend vertically near (e.g., proximate to) the outer case 23 of the filter module 14, and may be connected to a flow passage switching valve 31, which will be described later, via a water hose. A plurality of water backflow prevention valves 29 configured to prevent the water in the water storing cup 25 from flowing backward may be mounted in water outlets of the water dispenser 24. Each of the water backflow prevention valves 29 may include a housing 29c, a valve plate 29d, and a spring 29e.

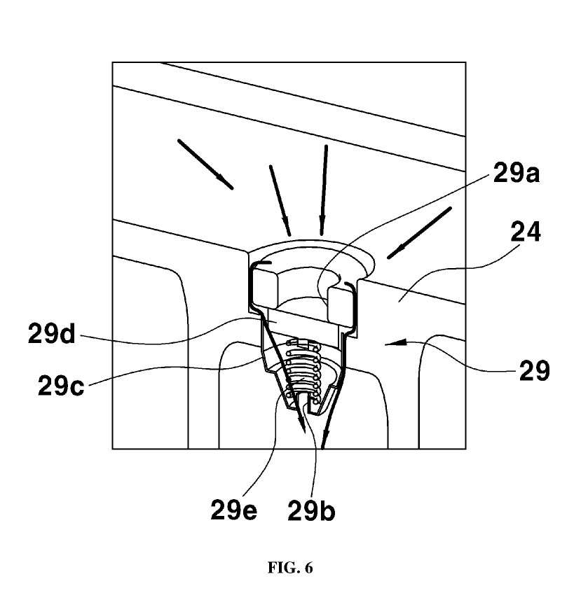

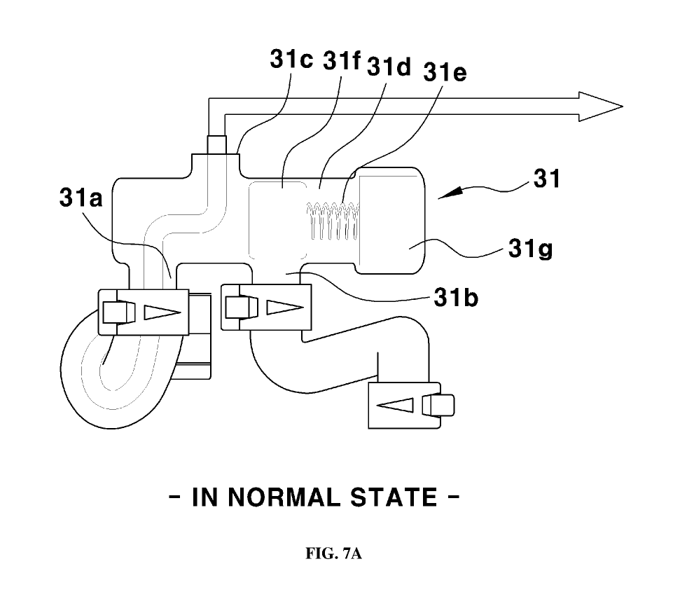

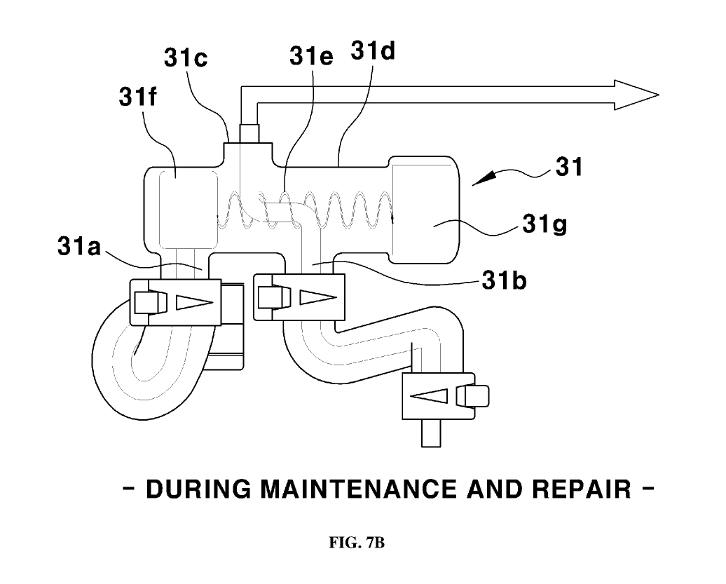

As shown in FIG. 6, the housing 29c may be mounted in each water outlet of the water dispenser 24, i.e., an aperture formed in the bottom of the water dispenser 24. The housing 29c may include a water inflow aperture 29a formed in the upper portion thereof and a water outflow aperture 29b formed in the lower portion thereof. The valve plate 29d may be mounted within the housing 29c to move vertically (e.g., up and down) to open and close the water inflow aperture 29a. The spring 29e may be disposed beneath the valve plate 29d. Further, the spring 29e may be configured to exert an elastic force on the valve plate 29d to push the valve plate 29d upwards.

When a predetermined amount of water is collected in the water dispenser 24, the valve plate 29d may be moved downwards against the elastic force of the spring by the weight of the water, thereby opening the water inflow aperture. Therefore, the water may flow into the water storing cup 25. Then, the water in the water storing cup 25 may be prevented from flowing backward by the valve plate 29d to close the water inflow aperture by the elastic force of the spring 29e.

The next-generation diesel fuel filter integrated with a fuel pump of the present invention may further include a flow passage switching valve 31, having a three-way valve configuration, configured to selectively perform the operation of supplying fuel to an engine or the operation of discharging water to the exterior. The flow passage switching valve may be embodied as a solenoid valve, configured to be turned ON/OFF based on whether electric power is applied thereto, thereby opening and closing the flow passage. The flow passage switching valve 31 may be supported by a cover body 40, mounted above the filter module 14 integrated with the pump module 17. The controller 39 may also be mounted to the cover body 40.

Further, the flow passage switching valve 31 may include a valve case 31d, a plunger 31f, a spring 31e, and a solenoid 31g. The valve case 31d may include two inlets 31a and 31b, a first inlet 31a being connected with the fuel outlet 11 of the filter module 14 and a second inlet 31b being connected with the water flow pipe 26 of the water-collecting module 28, and an outlet 31c, connected to the engine (or to the outside). The inlet 31a and the fuel outlet 11 may be connected to each other via a fuel hose, and the inlet 31b and the water flow pipe 26 may be connected to each other via a water hose.

The plunger 31f, configured to move to selectively block the inlets 31a and 31b while being supported by the spring 31e of the rear end, may be mounted in the valve case 31d, and the solenoid 31g, operated by the controller 39 and connected to the plunger 31f through a rod (not shown), may be mounted at a first end of the valve case 31d. Accordingly, when the solenoid 31g is turned ON, the plunger 31f may be configured to move forward, thereby closing the inlet 31a to receive fuel and opening the inlet 31b to receive water. In particular, water may be discharged to the outside when performing maintenance and repair work.

For example, when a connection line (not shown), such as a hose, is detached from the outlet 31c, and an additional water discharge hose (not shown) may be connected to the outlet 31c, water may be discharged to the outside. Further, when the solenoid 31g is turned OFF, the plunger 31f may be configured to move backward by the pulling force of the spring 31e, thereby opening the inlet 31a to receive fuel and closing the inlet 31b to receive water. In particular, fuel may be normally supplied to the engine. When the warning lamp associated with water removal is lit and maintenance and repair work for removing water is required, a quick connector (not shown) of a fuel line (which decreases the fuel pressure) may be disconnected in an engine stopped state or in an engine idling state.

Subsequently, whether the amount of fuel is less than a predetermined amount may be determined, at which a fuel warning lamp is set to be turned ON. When the amount of fuel is less than the predetermined amount, a predetermined amount of fuel (e.g., about 3 L) may be injected, and then the above determination process may be repeated. When the amount of fuel exceeds the predetermined amount, at which a fuel warning lamp is set to be turned ON, whether the fuel pressure is less than a predetermined pressure (e.g., about 2 bar) may be determined. When the fuel pressure is greater than the predetermined pressure, the quick connector of the fuel line may be uncoupled or disconnected. When the fuel pressure is less than the predetermined pressure, maintenance and repair work for removing water may be started.

Moreover, to remove water, an additional switch (not shown) may be manipulated to turn ON the solenoid of the flow passage switching valve 31, and an external hose may be connected to the outlet 31c to discharge the water in the water storing cup 25 of the water-collecting module 28 to the outside. The water discharging process may be realized by the operation of the pump module 17. For example, when the solenoid of the flow passage switching valve 31 is in an ON state (e.g., a state in which the inlet for receiving fuel is closed and the inlet for receiving water is open), when the pump module 17 is operated, a predetermined pressure may be generated in the filter module 14 including the reservoir cup 13 since the inlet through which the fuel flows out is closed, and accordingly the water in the water storing cup 25 may be discharged to the outside through the flow passage switching valve 31 owing to the pressure generated in the filter module.

Hereinafter, the operation of the next-generation diesel fuel filter integrated with a fuel pump constituted as above will be explained.

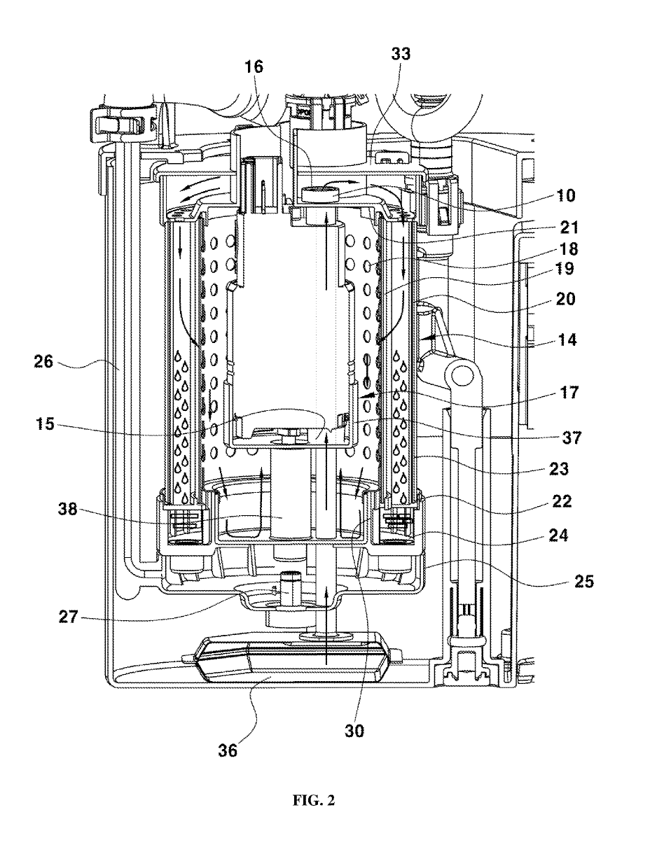

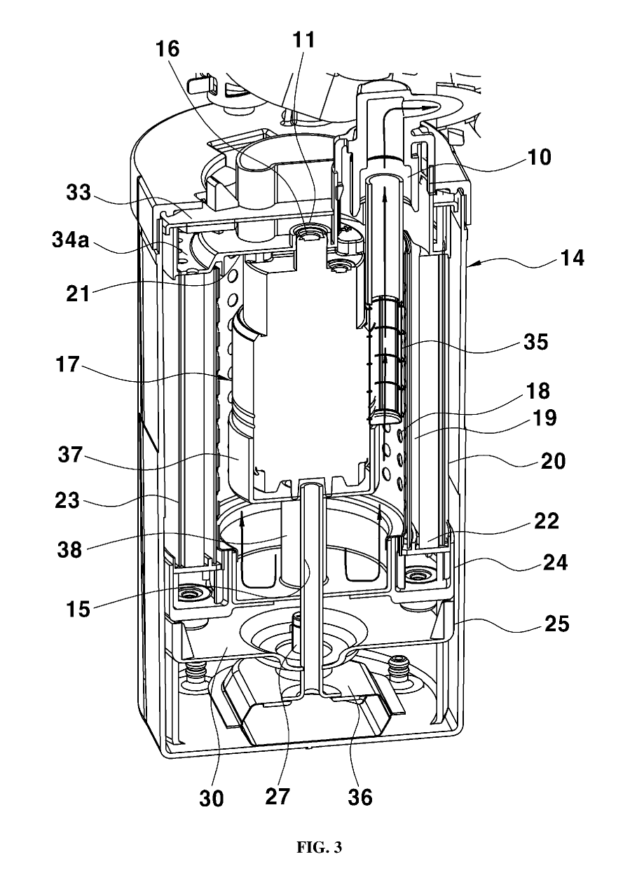

Referring to FIGS. 2 and 3, in the diesel fuel filter integrated with the fuel pump, mounted in the fuel tank, when the pump module 17 is operated, the fuel in the reservoir cup 13 may sequentially pass through the fuel pre-filter 36, the fuel suction aperture 15, the fuel discharge aperture 16 and the fuel inlet 10, and flow into the space between the upper filter cover 21 and the upper cover 33.

Subsequently, the fuel may flow into the space between the outer case 23 and the primary filter paper 20 through the fuel apertures 34a of the upper filter cover 21, and may sequentially pass through the primary filter paper 20, the secondary filter paper 19 and the filter guide 18 to be filtered to remove impurities therefrom. The filtered fuel may flow into the internal space of the filter guide 18. Then, the filtered fuel may flow out through the fuel delivery pipe 35 and the fuel outlet 11, and may be supplied to the engine after sequentially passing through the inlet 31a, the valve case 31d and the outlet 31c of the flow passage switching valve 31.

Further, the flow passage switching valve 31 may be in a state in which the solenoid is turned OFF, and therefore, the inlet 31a for receiving fuel may be in an open state. The water contained in the fuel, which has flowed into the space between the outer case 23 and the primary filter paper 20, may flow into the water dispenser 24 through the fuel apertures 34b of the lower filter cover 22 owing to the difference in specific gravity, and may gather or collect in the water storing cup 25 through the water backflow prevention valve 29.

As described above, since the diesel fuel filter integrated with a fuel pump of the present invention may be disposed in the fuel tank, problems of damages to the fuel filter due to vehicle collision, a deicing agent and of stone chipping may be solved. Even when a vehicle travels on an inclined road, at which time the fuel tank is in a slanted state, fuel may be reliably supplied due to a double reservoir structure, realized by the reservoir cup and the auxiliary reservoir cup.

The next-generation diesel fuel filter integrated with a fuel pump according to the present invention has the following advantages.

First, since the diesel fuel filter integrated with a fuel pump may be disposed in the fuel tank, problems of damage to the fuel filter due to vehicle collision, a deicing agent and of stone chipping may be solved, and safety in the event of a vehicle collision may be improved.

Secondly, the performance of a diesel fuel system may be improved by removing water at a suitable time using a water removing function and a water removal warning system.

Finally, the reliability of fuel supply may be enhanced even in a low fuel level state, such as when traveling on an inclined road, due to a double reservoir cup structure.

The invention has been described in detail with reference to exemplary embodiments thereof. However, it will be appreciated by those skilled in the art that changes may be made in these embodiments without departing from the principles and spirit of the invention, the scope of which is defined in the appended claims and their equivalents.

What is claimed is:

1. A next-generation diesel fuel filter integrated with a fuel pump, comprising:
a filter module including a fuel inlet, a fuel outlet, and a plurality of filter papers, the filter module being mounted in a reservoir cup; and
a pump module including a fuel suction aperture that communicates with an internal space of the reservoir cup, and a fuel discharge aperture that communicates with the fuel inlet, the pump module being mounted in the filter module,
wherein the pump module and the filter module are combined together and mounted in a fuel tank.

2. The next-generation diesel fuel filter integrated with a fuel pump of claim 1, wherein the filter module includes:
a mesh-shaped filter guide, a primary filter paper and a secondary filter paper to filter fuel; and
an outer case covered by an upper filter cover and a lower filter cover,
wherein the filter guide, the secondary filter paper, the primary filter paper and the outer case are concentrically and sequentially arranged from inside to outside.

3. The next-generation diesel fuel filter integrated with a fuel pump of claim 1, further comprising:
a water-collecting module configured to collect water filtered out of the fuel,
wherein the water-collecting module includes a water dispenser and a water storing cup sequentially coupled to a lower end of the filter module, a water flow pipe connected to a first side of the water storing cup and extending upwards, and a water sensor mounted in the water storing cup to sense an amount of water.

4. The next-generation diesel fuel filter integrated with a fuel pump of claim 3, further comprising:
a plurality of water backflow prevention valves mounted in water outlets of the water dispenser,
wherein each of the water backflow prevention valves includes a housing having a water inflow aperture formed in an upper portion thereof and a water outflow aperture formed in a lower portion thereof, a valve plate mounted in the housing to move vertically to open and close the water inflow aperture, and a spring mounted in the housing to elastically support the valve plate upwards.

5. The next-generation diesel fuel filter integrated with a fuel pump of claim 1, further comprising:
an auxiliary reservoir cup mounted to a lower end of the filter module to store a predetermined amount of fuel.

6. The next-generation diesel fuel filter integrated with a fuel pump of claim 1, wherein the filter module further includes:
a plurality of positive temperature coefficient (PTC) heat-generating elements configured to heat fuel,
wherein the PTC heat-generating elements are mounted to an upper cover, disposed proximate to the fuel discharge aperture of the pump module and the fuel inlet and the fuel outlet of the filter module.

7. The next-generation diesel fuel filter integrated with a fuel pump of claim 1, further comprising:
a flow passage switching valve configured to selectively perform an operation of supplying fuel or an operation of removing water,
wherein the flow passage switching valve includes: a valve case having two inlets connected with the fuel outlet of the filter module and connected with a water flow pipe of a water-collecting module, respectively, and an outlet connected to an engine, a plunger mounted in the valve case and supported by a spring to move and selectively block the two inlets of the valve case, and a solenoid configured to operate the plunger.

8. The next-generation diesel fuel filter integrated with a fuel pump of claim 3, wherein water collected in the water-collecting module is discharged outside by operating the pump module when a solenoid of a flow passage switching valve is turned ON.

9. The next-generation diesel fuel filter integrated with a fuel pump of claim 3, wherein a warning lamp is turned on when the water stored in the water storing cup reaches a predetermined level.
